(19) United States
(12) Patent Application Publication
(10) Pub. No.: US 2009/0288848 A1
(43) Pub. Date: Nov. 26, 2009

(54) TINED PRY BAR HAND TOOL

(75) Inventor: Steven E. Post, Arlington, MN (US)

Correspondence Address: HAMRE, SCHUMANN, MUELLER & LARSON, P.C., P.O. BOX 2902, MINNEAPOLIS, MN, 55402-0902, US

(73) Assignee: S.E.P.C.O., Arlington, MN (US)

(21) Appl. No.: 12/124,349

(22) Filed: May 21, 2008

(51) Int. Cl. A01B 1/00

(52) U.S. Cl. 172/378

(57) ABSTRACT

A tined pry bar hand tool includes a head that is formed by a unitary, one-piece block of metal. The head includes a plurality of tines integrally formed thereon. The construction of the head makes it less prone to breakage, and suitable for a variety of construction/demolition projects.

### FIELD

This disclosure relates to a pry bar hand tool useful for a variety of construction/demolition projects including, but not limited to, removing stucco, roofing, siding, decking, wood flooring, tile, drywall, plaster and lath, and millwork.

### BACKGROUND

Pry bar hand tools are known in the prior art that are purportedly suitable for removing items such as shingles, nails, and insulation. These known hand tools suffer from a number of problems. For example, these known hand tools are often designed to perform a single task, such as shingle and nail removal. However, users often try to use the tools to perform other construction/demolition tasks which the tools are not designed for. This can cause damage to the tools. In addition, because the tools are used under rugged conditions, these tools are often designed to have replacement parts which can make the replaceable portions of the tools weak and prone to breakage during use.

### SUMMARY

A tined pry bar hand tool is described that is designed for use in a large number of construction/demolition projects including, but not limited to, removing stucco, roofing, siding, decking, wood flooring, tile, drywall, plaster and lath, and millwork. The tool is rugged and long lasting. In addition, since it is a hand tool, the tool is relatively light in weight which is an important consideration as the tool may often be held above a users head during use. For example, the tool can have a weight of about 7 pounds or less, compared with a weight of 9 or 10 pounds or more in some prior pry bar hand tools.

In one embodiment, the tined pry bar hand tool includes a head formed by a unitary, one-piece block of metal. The head has a substantially horizontal bottom surface with a front edge and a rear edge. A substantially planar, vertical rear surface extends upwardly from the rear edge of the bottom surface to a top edge. A substantially horizontal top surface portion extends forwardly from the top edge, with the top surface portion being parallel to the bottom surface. A continuously angled portion extends from an end of the top surface portion to the front edge of the bottom surface. A plurality of tines extend from the front edge toward the rear surface and end a predetermined distance from the top surface portion. The tines are generally rectangular with front edges that correspond to the front edge of the bottom surface and that are substantially parallel to the rear edge. Gaps are formed between the plurality of tines, with the gaps extending vertically from the continuously angled portion to the bottom surface and extending from the front edges of the tines to rear ends of the gaps. The gaps decrease continuously in width from the front edges to the walls. In addition, a handle is connected to the head, with the handle including a shaft extending from the rear surface.

### DESCRIPTION OF THE DRAWINGS

FIG. 1 is a perspective view of the tined pry bar tool.

FIG. 2 is a side view of the tined pry bar tool of FIG. 1.

FIG. 3 is a top view of the head of the tined pry bar tool.

FIG. 4 illustrates details of the connection between the shaft and the head.

### DETAILED DESCRIPTION

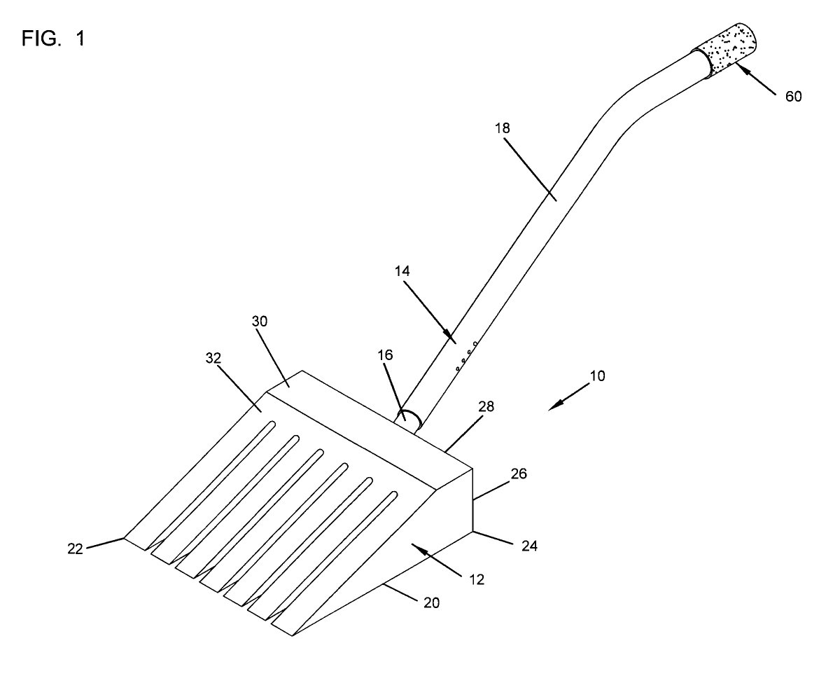

With reference initially to FIG. 1, a tined pry bar tool 10 is illustrated as including a head 12 and a handle 14. The head 12 is a unitary, one-piece construction of a block of metal such as steel. By making the head out of a single piece of metal, breakage of parts and loosening of connections is minimized.

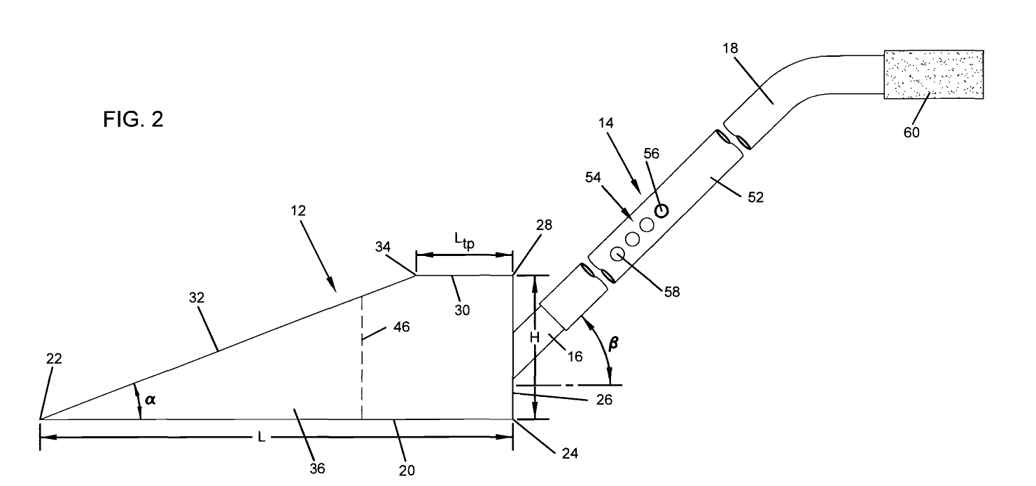

With reference to FIG. 1 and 2, the head 12 has a substantially flat, horizontal bottom surface 20 extending from a non-continuous front edge 22 of the head to a bottom rear edge 24. A substantially flat, vertical rear surface 26 extends upwardly from the rear edge 24 to a top, rear edge 28 of the head. A substantially horizontal, solid top surface portion 30 extends forwardly from the top, rear edge 28 to a continuously angled portion 32 that extends from an end 34 of the top surface portion 30 to the front edge 22. The top surface portion 30 is substantially parallel to the bottom surface 20. In addition, the head 12 includes substantially vertical, solid side surfaces 36 that extend from the bottom surface 20 to the top surface portion 30 and the angled portion 32, and extends from the front edge 22 to the rear surface 26. Only one side surface is visible in FIG. 2; it being understood that the opposite side surface is identical to the surface 36 that is visible in FIG. 2.

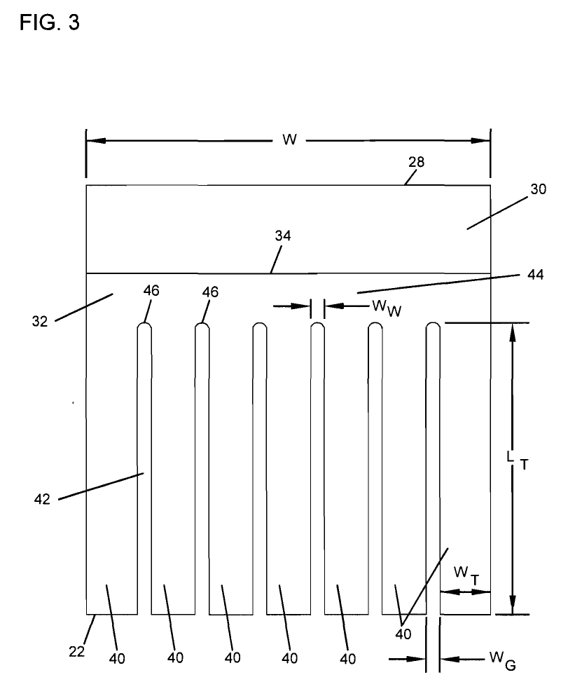

With reference to FIG. 3, the head 12 includes a plurality of integrally formed tines 40. The tines 40 are formed by creating spaced gaps or slots 42 in the head 12 that extend from the front edge 22 toward the rear surface 26, and from the continuously angled portion 32 to the bottom surface 20. The gaps 42 stop short of the end 34 of the top surface portion 30, so that there is a section 44 of the angled portion 32 between the ends of the gaps 42 and the end 34 of the top surface portion 30 that is solid.

The tines 40 thus extend from the front edge 22 toward the rear surface 26, stopping short of the top surface portion 30. The tines 40 are generally rectangular when viewed in the top plan view of FIG. 3, with front edges that correspond with the front edge 22 and that are substantially parallel to the top, rear edge 28. Thus, the tines 40 can be described as having front edges 22, it being realized that the front edge 22 is non-continuous as it is formed by all of the front edges of the tines 40. The gaps 42 have rear ends that define walls 46 that extend substantially vertically from the angled portion 32 to the bottom surface 20. The gaps 42 decrease continuously in width W from the front edge 22 to the walls 46 whereby the tines 40 increase continuously in width from the front edges 22.

The head 12 can have the following exemplary dimensions. With reference to FIG. 2, the length L can be about 4.0 inches, the height H about 1.25 inches, the length Lₜₚ of the top surface portion 30 of about 0.75 inches, and the angle a between the angled portion 32 and the bottom surface 20 of about 20 degrees. With reference to FIG. 3, the head 12 can have a constant width W between the side surfaces 36 from the rear surface 26 to the front edge 22 of about 3.75 inches, the tines can have a length L_{T} of about 2.75 inches, each tine can have a width W_{T} of about 0.375 inches, each gap can have a width W_{G} at the front edges of about 0.1875 inches, and the rear ends of the gaps 42 can have a width W_{W} of about 0.09375 inches. Although it is to be realized that other dimensions could be used, these particular dimensions are beneficial for a number of reasons. The angle α provides more leverage for prying compared to prior art designs which have an angle of about 15 degrees. In addition, the top surface portion 30 helps to reduce the weight of the head 12 compared to a head where the rear surface 26 and the angled portion 32 directly join. Further, the tines are wider than tines on prior art tools, which increases the strength of the tines making them less prone to breakage.

The handle 14 extends from the rear surface 26 at an angle β of about 40 degrees relative to horizontal. Referring to FIGS. 1, 2 and 4, the handle 14 comprises a substantially solid shaft 16 that is connected to the head 12 and extends from the rear surface 26, and a sleeve 18 that surrounds the shaft 16. The shaft 16 and sleeve 18 are made of metal, for example aluminum.

The shaft 16 and sleeve 18 are generally circular, although other shapes, such as square, can be used. The sleeve 18 is slidably disposed around the shaft 16 to permit adjustment in the length of the handle 14. An adjustable locking mechanism 54 is provided between the shaft 16 and the sleeve 18 to allow adjustment of the handle length. For example, as illustrated, the adjustable locking mechanism 54 can be formed by a spring loaded button 56 disposed toward an end of the shaft 16, and a number of holes 58 formed in the sleeve 18. By pushing in the button 56 and sliding the sleeve 18 relative to the shaft 16 until the button snaps into place in a new hole 58, the length of the handle 14 can be adjusted. Other adjustable locking mechanisms can be used as well. To facilitate the users grip on the tool, the free end of the handle 14 can be provided with a rubber sleeve 60.

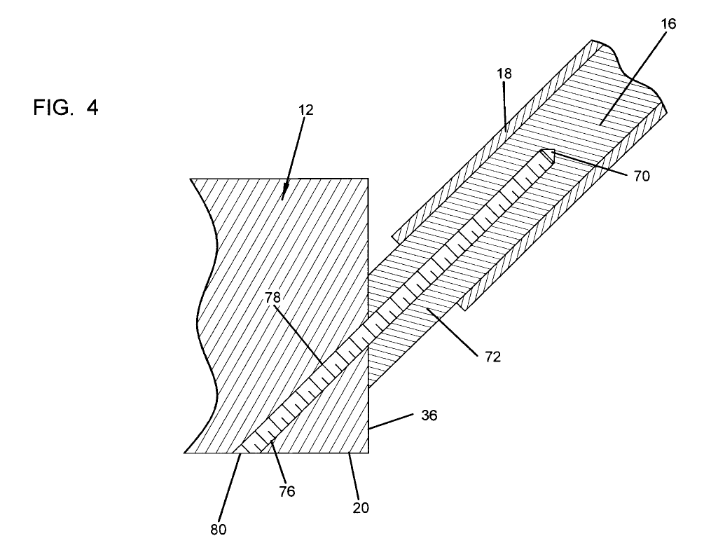

It is important that a secure connection be provided between the handle 14 and the head 12. An exemplary connection is illustrated in FIG. 4. A hole 70 is drilled into the end 72 of the shaft 16, and the hole is tapped to create internal threads. The end 72 of the shaft 16 is also cut to provide the proper angle for mating with the rear surface 36. In addition, a hole 76 is drilled through the head 12 extending from the bottom surface 20 to the rear surface 36. The hole 76 is also tapped to create threads. A threaded rod 78 is then threaded into the hole 76in the head 12 and into the hole 70 in the shaft 16. This draws the end 72 of the handle 16 into intimate contact with the rear surface 36 of the head 12. Once the rod 78 is fully inserted, any of the rod 78 extending out of the hole 76 from the bottom surface 20 is cut off, and the hole at the bottom surface 20 is welded closed 80.

The tined pry bar hand tool described herein may be embodied in other forms without departing from its spirit or characteristics. The described embodiments are to be considered in all respects only as illustrative and not restrictive. The scope of the invention is therefore indicated by the appended claims rather than by the foregoing description. All changes which come within the meaning and range of equivalency of the claims are to be embraced within their scope.

1. A tined pry bar hand tool, comprising:
a head formed by a unitary, one-piece block of metal, the head having:
i) a substantially horizontal bottom surface with a front edge and a rear edge;
ii) a substantially planar, vertical rear surface extending upwardly from the rear edge of the bottom surface, the rear surface having a top edge;
iii) a substantially horizontal and continuous top surface portion extending forwardly from the top edge, the top surface portion is parallel to the bottom surface;
iv) a continuously angled portion extending from an end of the top surface portion to the front edge of the bottom surface;
v) a plurality of tines that extend from the front edge toward the rear surface, the tines end a distance from the top surface portion, and the tines are rectangular with front edges that correspond to the front edge of the bottom surface and that are substantially parallel to the rear edge; and
vi) gaps between the plurality of tines, the gaps extend vertically from the continuously angled portion to the bottom surface and extend from the front edges of the tines to rear ends of the gaps;
a handle connected to the head, the handle comprising a shaft extending from the rear surface.
wherein the handle extends from the rear surface at an angle of about 40 degrees relative to the bottom surface.

2. The tined pry bar hand tool of claim 1, wherein the angled portion has an angle of about 20 degrees relative to the bottom surface.

3. The tined pry bar hand tool of claim 1, wherein the top surface portion has a horizontal distance of about 0.75 inches.

4. The tined pry bar hand tool of claim 1, wherein the head comprises a threaded hole extending through the head from the bottom surface to the rear surface, and the shaft has an end with a threaded hole, and comprising a threaded rod extending through the threaded hole in the head and into the threaded hole in the end of the shaft.

5. The tined pry bar hand tool of claim 1, wherein the front edge of each tine has a width of about 0.375 inches, each gap has a width of about 0.1875 inches at the front edges of the tines and a width at a rear end of each gap is about 0.09375 inches.

6. The tined pry bar hand tool of claim 1, wherein the handle further comprises a sleeve slideably disposed on the shaft, and an adjustable locking mechanism between the shaft and the sleeve that permits adjustment of the sleeve relative to the shaft to adjust the length of the handle.

7. The tined pry bar hand tool of claim 6, wherein the adjustable locking mechanism is formed by a spring loaded button disposed toward an end of the shaft, and a plurality of holes formed along the sleeve.
